(19) United States
(12) Patent Application Publication
(10) Pub. No.: US 2017/0171630 A1
(43) Pub. Date: Jun. 15, 2017

(54) Sharing Portions of a Video

(71) Applicant: International Business Machines Corporation, Armonk, NY (US)

(72) Inventors: Su Liu, Austin, TX (US); Eric J. Rozner, Austin, TX (US); Chin Ngai Sze, Austin, TX (US); Yaoguang Wei, Austin, TX (US)

(21) Appl. No.: 14/967,977

(22) Filed: Dec. 14, 2015

(51) Int. Cl. H04N 21/472; H04N 21/442; H04N 21/61; H04N 21/422; H04N 21/437; H04L 29/08; H04N 21/235

(52) U.S. Cl. CPC H04N 21/47217; H04L 67/1097; H04L 67/02; H04L 67/12; H04N 21/44218; H04N 21/2353; H04N 21/42201; H04N 21/437; H04N 21/6175

(57) ABSTRACT

An approach is provided for sharing a portion of a video on a social media website. The approach receives a starting point associated with the video and an ending point associated with the video. The starting and ending points are received a user that is sharing the video on the social media website. The starting and ending points are stored as metadata accessible by users of the social media website. A playback request is received from another user of the social media website. The shared video is played to the second user from the starting point of the shared portion to the ending point of the shared portion.

### BACKGROUND OF THE INVENTION

Technical Field

This disclosure relates to sharing portions of content rather than an entire piece of content with another user or users.

Description of Related Art

Watching and sharing video become the most activities for the most social media users. Many internet users share videos across their social feeds more than once a week. The culture of sharing videos becomes a hot topic in social media publisher and vendors. Many social media and video sharing vendor have incentive programs to encourage users to share videos to friends. In addition, social commerce and behavioral economics are increasingly popular areas for investment with several billion dollars in revenue anticipated in 2015, largely due to the fact that there are billions of mobile users involved in different social communities. In social media platforms, it is not easy to share a portion of video, instead of the entire video file. Today, a user has to edit a video file to create a second video file that contains the portion that the user wishes to share. This is often a time consuming process. On some platforms, the user may have to purchase software to perform this editing task. On the receiving side, the receiver also has no idea which portion of a video the provider wants to receiver to view. This wastes the receiver's time in having to scan through the video to find the portion of interest. Oftentimes, the receiver will simply skip viewing the video because he or she does not have the time to scan through a long video to find the relatively short portion of interest.

### SUMMARY

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a processor and components of an information handling system;

FIG. 2 is a network environment that includes various types of information handling systems interconnected via a computer network;

FIG. 3 is a component diagram depicting an exemplary environment that allows a user to share a portion of content with other users;

FIG. 4 is a flowchart showing overall processing performed in sharing a portion of content with other users; and

FIG. 5 is a flowchart showing steps taken a process plays, or performs, the portion of content when received by the receiving users.

### DETAILED DESCRIPTION

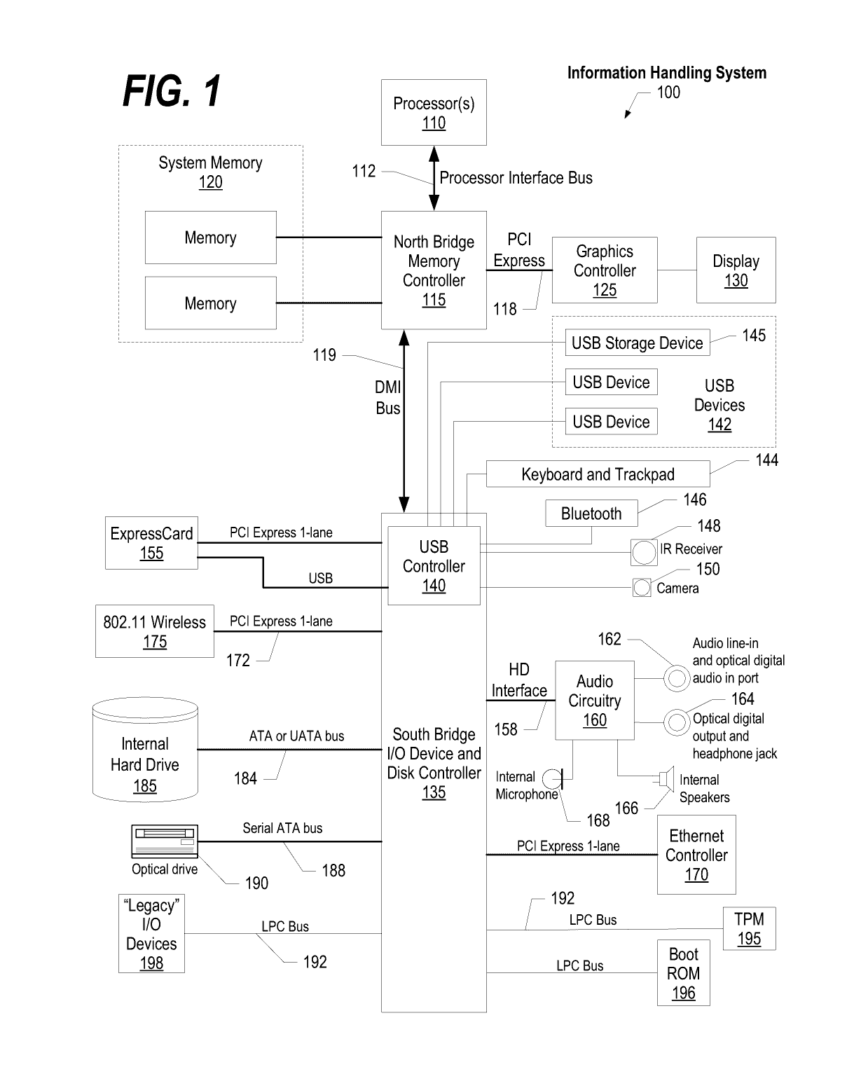

FIGS. 1-5 show an approach for detecting a portion of content, such as video, and sharing on a social media platform. The video feature is integrated with context-aware tracking mechanism for improving video sharing service on social media. The illustrative embodiments in the attached figures generate a function to automatically select user interested video portions based on video watch reaction. The illustrative embodiment tracks whether any of the reactions is a valid interesting signal according a video watch-reaction patterns. The illustrative embodiment records all positions of starts and ends of interested positions associated with the user video watching reactions. Then, the illustrative embodiment stores a virtual video with set of tagged video links in social media server as alternate shared video link. The tagged video links can have multiple interested levels. Finally, each shared receiver gets the virtual video and can watch the shared video either based on either own or senders defined interested levels.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

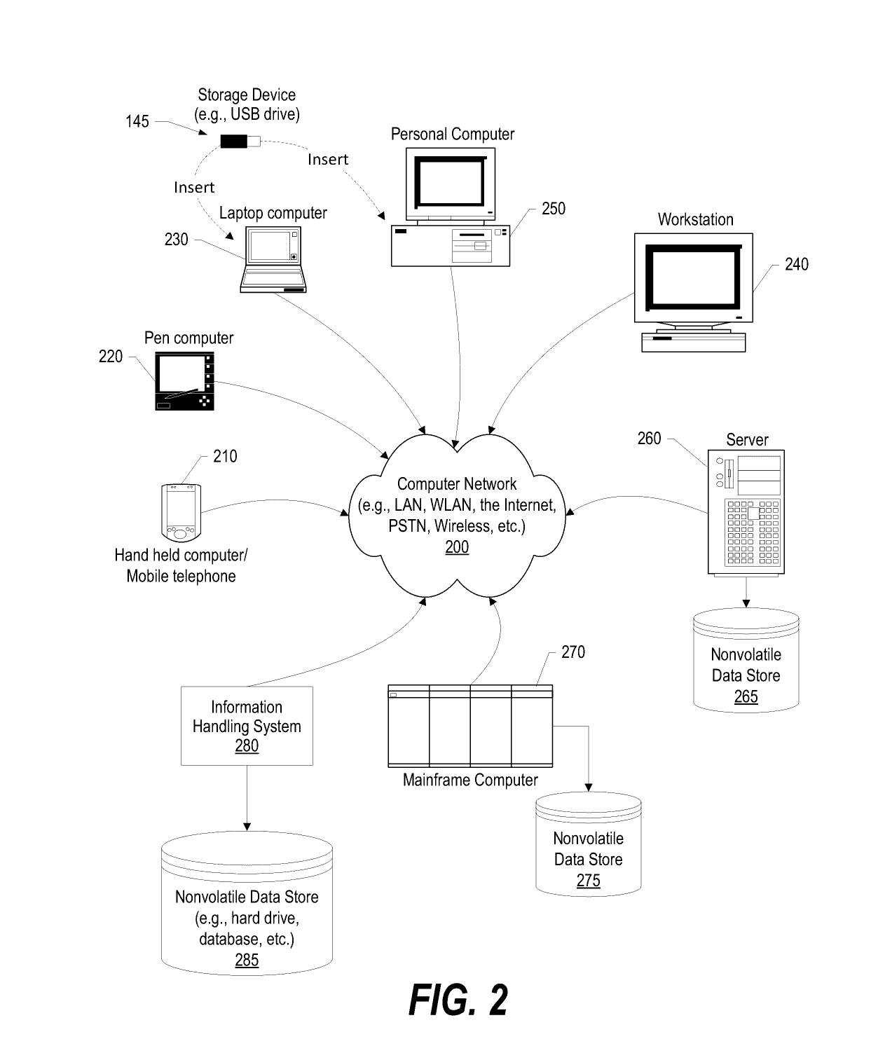

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119.

In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, et cetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

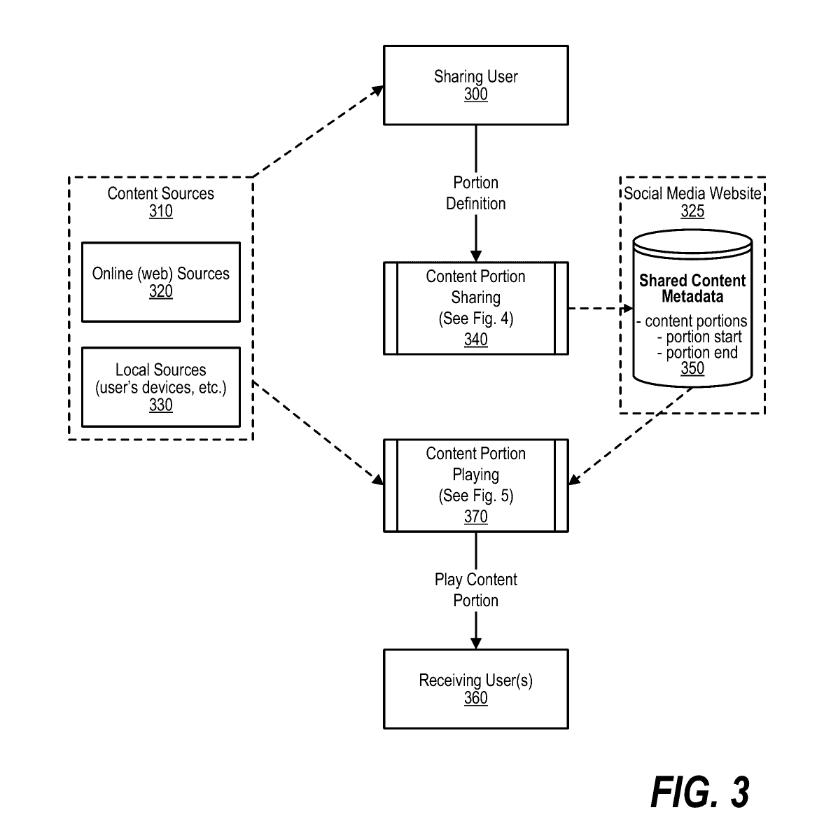

FIG. 3 is a component diagram depicting an exemplary environment that allows a user to share a portion of content with other users. Sharing user 300 shares a video with other users, such as friends and colleagues, that form a community on social media website 325. The video that is shared can be from a variety of content sources 310. These sources can include online sources 320 as well as local sources 330. Local sources can be storage on one of the sharing user's devices, such as the user's smart phone, tablet, computer system, or the like. Depending on the accessibility of the video that is being shared, either a link to the video or the actual video content is shared on social media website 325. For example, if the video being shared is publicly accessible from another online source, such as another website, then a link (e.g., URL, etc.) might be shared on social media website. On the other hand, if the content is located on one of the user's personal devices that does not share storage with users of the social media website, such as the user's smart phone or tablet, then the actual video contents are copied from such device to social media website 325.

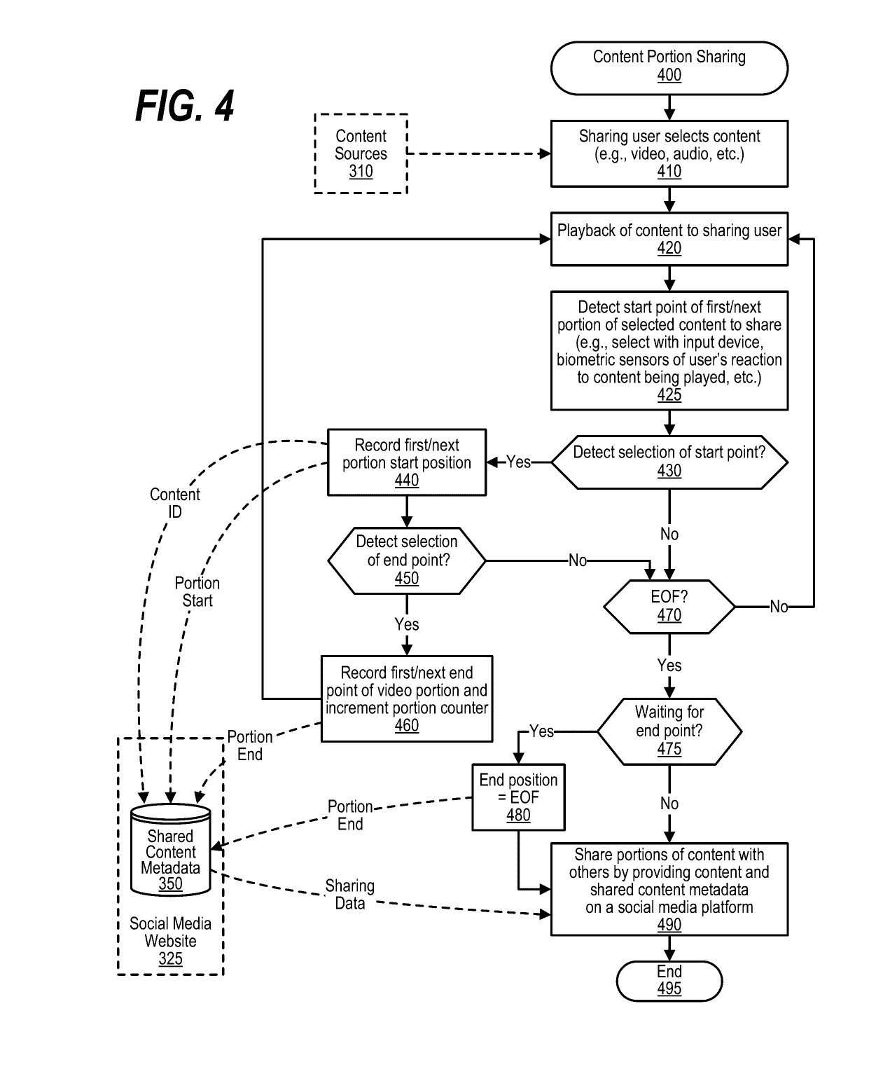

Predefined process 340 is used by user 300 that is sharing the video to define the portion of the video that is being shared (see FIG. 4 and corresponding text for processing details). The result of predefined process 340 is metadata 350 that stored in a location accessible to the social media website, such as on the social media website's nonvolatile storage devices. Shared content metadata includes the defined starting point of the portion of the video that is being shared as well as the defined ending point of the portion of the video that is being shared.

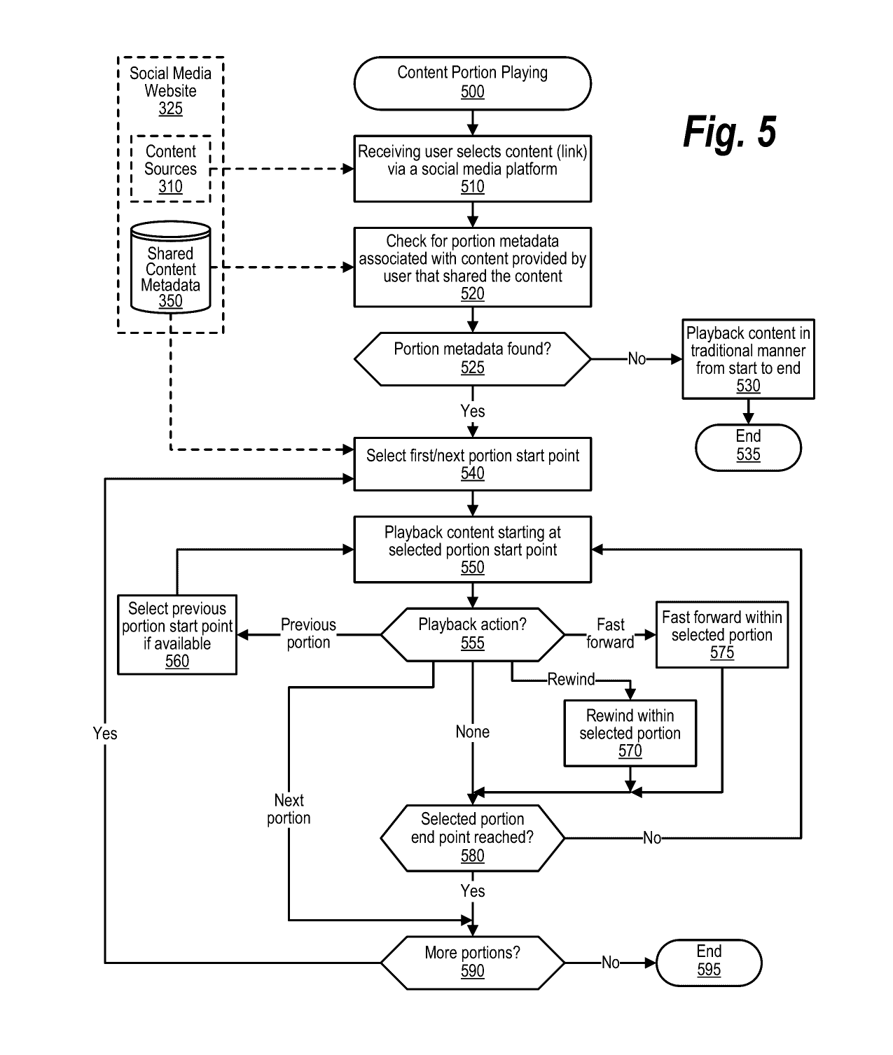

Predefined process 370 is used by any one of the social media users 360 that has access to the video by way of the sharing user (see FIG. 5 and corresponding text for processing details). Some social media websites might require receiving users 360 be noted as “friends” or “colleagues” of sharing user 300 in order to view content, such as videos, shared by user 300. Predefined process 370 plays the portion of the video that was shared by user 300 from the starting point of the portion to the ending point of the portion.

FIG. 4 is a flowchart showing overall processing performed in sharing a portion of content with other users. FIG. 4 processing commences at 400 and shows the steps taken by a process that defines portions of a video that is being shared by a user. At step 410, the user shares a selected video on a social media website. At step 420, the process commences playback of the video to the sharing user. At step 425, the process detects a start point of the first portion of selected content to share based on a user action. The user action can be an action performed by the user using an input device (e.g., keyboard, mouse, etc.) or an action in the form of a reaction sensed by one or more biometric sensors that sense the user's reaction when watching the video (e.g., laugh, smile, exclamation, etc.). The process determines as to whether a start point of the video portion was detected from the user (decision 430). If a start point of the video portion was detected, then decision 430 branches to the ‘yes’ branch to record and process the portion of the video. On the other hand, if a start point of the video portion was not detected, then decision 430 branches to the ‘no’ branch which next determines whether the end of the video (EOF) has been reached.

When the user has indicated a start point of the video portion, then decision 430 branches to the ‘yes’ branch whereupon, at step 440, the process records the first portion's start point in metadata 350. The process next determines whether an end point of the video portion has been detected like the detection performed at step 425 (decision 450). If an end point of the video portion has been detected, then decision 450 branches to the ‘yes’ branch whereupon, at step 460 the process records the end point of the first video portion in metadata 350. Processing also increments the portion counter so that another start/end point detected from the user will define the next portion of the video. In this manner, multiple portions of a video can be defined by the user. Processing then loops back to step 420 to continue playback of the video to the user.

Returning to decision 450, if an end point of the video portion has not been detected, then decision 450 branches to the ‘no’ branch which next determines whether the end of the video (EOF) has been reached. During playback of the video, the repeatedly determines whether the end of the video (EOF) has been reached (decision 470). If the end of the video has been reached, then decision 470 branches to the ‘yes’ branch for end processing. On the other hand, if the end of the video has not been reached, then decision 470 branches to the ‘no’ branch which loops back to step 420 to continue playback of the video to the sharing user and detection of start and end points of the various portions defined by the sharing user.

When the end of the video has been reached, decision 470 branches to the ‘yes’ branch whereupon the process determines whether the process was waiting for the user to select an end point for a start point that has been established by the user (decision 475). If the process was waiting for the user to select an end point, then decision 475 branches to the ‘yes’ branch whereupon, at step 480, the last end position for the last portion defined by the user is set to be equal to the end of the video. On the other hand, if the process was not waiting for the user to select an end point, then decision 475 branches to the ‘no’ branch bypassing step 480. At step 490, the process shares the portions of the video on social media website with others users of the social media website by providing the video (either a link to a video file accessible from the social media website or an actual digital video file) and metadata 350 that defines the start and stop points for the various portions defined by the user during the process described above. FIG. 4 processing thereafter ends at 495.

FIG. 5 is a flowchart showing steps taken a process plays, or performs, the portion of content when received by the receiving users. FIG. 5 processing commences at 500 and shows the steps taken by a process that plays video portions to a receiving user that is utilizing the social media website. At step 510, the user selects a video via a link provided on a social media platform where the sharing user shared the video. At step 520, the process checks for metadata in data store 350 that is associated with the video provided by user that shared the video. The process determines whether metadata for the video was found in metadata 350 (decision 525). If metadata for the video was found, then decision 525 branches to the ‘yes’ branch to playback the portions of the video that were defined by the sharing user. On the other hand, if metadata for the video was not found, then decision 525 branches to the ‘no’ branch whereupon, at step 530, the process play the video in the traditional manner from the start of the video to end the end of the video and processing ends at 535.

In response to metadata being found defining one or more portions of the video in metadata 350 then, at step 540, the process selects the first portion start point. The sharing user has defined at least one portion with a starting point and ending point and might have defined multiple portions in the video. At step 550, the process commences playback of the first portion of the video starting at the selected starting point. The process determines as to whether a playback action was selected by the receiving user that is viewing the video portion (decision 555). If a playback action was selected, then decision 555 branches to the appropriate branch to perform the selected playback action. On the other hand, if no playback action was selected, then decision 555 branches to the ‘no’ branch to perform decision 580. If the user selected a previous segment action then, at step 560, the process selects the previous segment's start point if available and processing loops back to commence playback of the previous portion using the selected start point. If the user selected a next segment action, then decision 555 branches to the ‘next segment’ branch which exits the current loop and branches to “more segments” decision 590. If the user selected a rewind action, then at step 570, the process rewinds the video within the selected segment. If the user selected a fast forward action, then at step 575, the process fasts forwards the video within the selected portion. During playback and fast forwarding of a video portion, the process repeatedly determines whether the end of the selected portion has been reached (decision 580). If the end of the selected portion has not been reached, then decision 580 branches to the ‘no’ branch which loops back to step 550 to continue playing the selected portion of the video to the receiving user on the social media website. This looping continues until the end of the selected portion has been reached, at which point decision 580 branches to the ‘yes’ branch exiting the loop. The process next determines whether there are more portions of the video that have been defined in metadata 350 (decision 590). If whether there are more portions of the video that have been defined, then decision 590 branches to the ‘yes’ branch which loops back to step 540 to commences playback of the next portion of the video as defined by the starting and ending points that were defined by the sharing user and stored in metadata 350. This looping continues until there are no more portions of the video to play, at which point decision 590 branches to the ‘no’ branch exiting the loop. FIG. 5 processing thereafter ends at 595.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method implemented by an information handling system that includes a processor and a memory accessible by the processor, the method comprising:
receiving, from a first user that is sharing a portion of a video on a social media website, a starting point within the video and an ending point within the video, wherein the starting and ending points define the shared portion of the video, and wherein the shared portion of the video is less than the shared video, and wherein the receiving further comprises:
detecting the starting point based on a first reaction from the first user when the video is played to the first user; and
detecting the ending point in response to the playing of the video reaching an end of the video;
storing the starting and ending points as metadata accessible by a plurality of users, including the first user, of the social media website;
receiving a playback request from a second user from the plurality of users; and
playing the shared portion of the video to the second user from the starting point of the shared portion of the video to the ending point of the shared portion of the video.

2. (canceled)

3. The method of claim 1 wherein at detecting the starting point based on a first reaction from the first user further comprises detecting the first reaction, wherein the first reaction is selected from the group consisting of an action by the first user on an input device, and a biometric reading received from a biometric sensor that is sensing one or more emotions of the first user.

4. (canceled)

5. The method of claim 1 further comprising:
receiving a plurality of starting points and ending points that define a plurality of shared portions of the video, wherein the plurality of starting points include the starting point, the plurality of ending points include the ending point, and the plurality of shared portions include the shared portion;
storing the plurality of starting and ending points as metadata accessible from the plurality of users of the social media website; and
playing the shared portions of the video to the second user from a first starting point from the plurality of starting points to a first ending point from the plurality of ending points then from a second starting point from the plurality of starting points to a second ending point from the plurality of ending points.

6. The method of claim 5 further comprising: during playing of the shared portions of the video to the second user, receiving a playback action request from the second user; and
performing the playback action within the plurality of portions defined for the video.

7. The method of claim 6 wherein the playback action is selected from the group consisting of a fast forward action, a rewind action, a skip to next portion action, and a skip to previous portion action.

8. An information handling system comprising:
one or more processors;
a memory coupled to at least one of the processors; and
a set of computer program instructions stored in the memory and executed by at least one of the processors in order to perform actions comprising:
receiving, from a first user that is sharing a portion of a video on a social media website, a starting point within the video and an ending point within the video, wherein the starting and ending points define the shared portion of the video, and wherein the shared portion of the video is less than the video, and wherein the receiving further comprises:
detecting the starting point based on a first reaction from the first user when the video is played to the first user; and
detecting the ending point in response to the playing of the video reaching an end of the video;
storing the starting and ending points as metadata accessible by a plurality of users, including the first user, of the social media website;
receiving a playback request from a second user from the plurality of users; and
playing the shared portion of the video to the second user from the starting point of the shared portion of the video to the ending point of the shared portion of the video.

9. (canceled)

10. The information handling system of claim 8 wherein detecting the starting point based on a first reaction from the first user further comprises detecting the first reaction, wherein the first reaction is selected from the group consisting of an action by the first user on an input device, and a biometric reading received from a biometric sensor that is sensing one or more emotions of the first user.

11. (canceled)

12. The information handling system of claim 8 wherein the actions further comprise:
receiving a plurality of starting points and ending points that define a plurality of portions of shared portions of the video, wherein the plurality of starting points include the starting point, the plurality of ending points include the ending point, and the plurality of shared portions include the portion;
storing the plurality of starting and ending points as metadata accessible from the plurality of users of the social media website; and
playing the shared portions of the video to the second user from a first starting point from the plurality of starting points to a first ending point from the plurality of ending points then from a second starting point from the plurality of starting points to a second ending point from the plurality of ending points.

13. The information handling system of claim 12 wherein the actions further comprise:
during playing of the shared portions of the video to the second user, receiving a playback action request from the second user; and
performing the playback action within the plurality of portions defined for the video.

14. The information handling system of claim 13 wherein the playback action is selected from the group consisting of a fast forward action, a rewind action, a skip to next portion action, and a skip to previous portion action.

15. A computer program product stored in a computer readable storage medium, comprising computer program code that, when executed by an information handling system, performs actions comprising:
receiving, from a first user that is sharing a portion of a video on a social media website, a starting point within the video and an ending point within the video, wherein the starting and ending points define the shared portion of the video, and wherein the shared portion of the video is less than the video, and wherein the receiving further comprises:
detecting the starting point based on a first reaction from the first user when the video is played to the first user; and
detecting the ending point in response to the playing of the video reaching an end of the video;
storing the starting and ending points as metadata accessible by a plurality of users, including the first user, of the social media website;
receiving a playback request from a second user from the plurality of users; and
playing the shared portion of the video to the second user from the starting point of the shared portion of the video to the ending point of the shared portion of the video.

16. (canceled)

17. The computer program product of claim 15 wherein detecting the starting point based on a first reaction from the first user further comprises detecting the first reaction, wherein the first reaction is selected from the group consisting of an action by the first user on an input device, and a biometric reading received from a biometric sensor that is sensing one or more emotions of the first user.

18. (canceled)

19. The computer program product of claim 15 wherein the actions further comprise:
receiving a plurality of starting points and ending points that define a plurality of portions of shared portions of the video, wherein the plurality of starting points include the starting point, the plurality of ending points include the ending point, and the plurality of shared portions include the portion;
storing the plurality of starting and ending points as metadata accessible from the plurality of users of the social media website; and
playing the shared portions of the video to the second user from a first starting point from the plurality of starting points to a first ending point from the plurality of ending points then from a second starting point from the plurality of starting points to a second ending point from the plurality of ending points.

20. The computer program product of claim 19 wherein the actions further comprise:
during playing of the shared portions of the video to the second user, receiving a playback action request from the second user; and
performing the playback action within the plurality of portions defined for the video, wherein the playback action is selected from the group consisting of a fast forward action, a rewind action, a skip to next portion action, and a skip to previous portion action.
